(19) United States
(12) Patent Application Publication
(10) Pub. No.: US 2002/0169872 A1
(43) Pub. Date: Nov. 14, 2002

(54) Method for arranging information, information processing apparatus, storage media and program tranmission apparatus

(76) Inventor: Hiroshi Nomiyama, Kasawaki-shi (JP)

Correspondence Address: Frank Chau, F. CHAU & ASSOCIATES, LLP, Suite 501, 1900 Hempstead Turnpike, East Meadow, NY, 11554, US

(21) Appl. No.: 09/854,615

(22) Filed: May 14, 2001

(51) Int. Cl. G06F 15/173; G06F 15/16

(52) U.S. Cl. 709/224; 709/218

(57) ABSTRACT

The present invention periodically observes a plurality of dynamically changing information sources obtained from the Internet, and automatically extracts a more important topic among the extracted information elements in view of support relations between sites and a degree of interest of individuals, and organize and visualize them in a comprehensible format. A process of the present invention includes the steps of: periodically circulating a plurality of registered information sources to collect information (S102); selecting words for topical elements from the collected information (S103); clustering the selected set of words (S104); and based on the result of clustering, displaying information elements in each cluster based on the time base, and displaying main keywords from among a set of words in each cluster (S105).

### BACKGROUND OF THE INVENTION

1. Field of the Invention

The present invention relates to information retrieval from information sources, and more particularly to a method for retrieving and visualizing topical information from a plurality of information sources on the Internet.

2. Discussion of Related Art In recent years, with the maintenance of the Internet, a huge amount of information has become available for users. An information retrieval technique for arranging and providing information which a user requires as early and accurately as possible and in the convenient form is increasingly important.

As a conventional information retrieval technique, there is one for retrieving an element (a link and its title, a series of texts, etc.) which delivers information from registered information sources (sites), and linguistically analyzing its text part. Also there is a technique which extracts topics utilizing portal sites that provide information service such as retrieval service or news. A Portal site offers a service for providing topical keywords created manually, where there is a service for providing a keyword to a retrieving user with utilizing a keyword ranking indicating a topic, for example.

Document 1 (J. Kleinberg, Authoritative sources in a hyperlinked environment, Proc. 9th ACM-SIAM Symposium on Discrete Algorithm; also appearing as IBM Research Report RJ 10076, May 1997) discloses a technique for calculating a significance in view of momentary static structural reference relations (supports) on the Internet. Here an authoritative page (Authority) for the specified retrieval equation and a page including many authoritative pages (Hub) are extracted. Also document 2 (Yanase and Nakao, “Automatic extraction of noteworthy news using a mail magazine”, 57-20, pp. 151-158, Information Processing Society of Japan, Information Technology Basic Research Society Resumes, Feb. 22, 2000) discloses a technique for automatically extracting noteworthy news from a plurality of information sources (mail magazines). Here, as a significance for the clustered results, an index is used which indicates that the number of information sources is large (i.e., there are many kinds of mail magazines).

On the other hand, Japanese Unexamined Patent Publication No. 1996-287074 discloses a technique for monitoring in real time a frequency of occurrence of unregistered words which appear in continuously published documents and recent documents, and defining the words and documents relating to currently noteworthy topics to users. In addition, Japanese Unexamined Patent Publication No. 1999-143892 discloses a technique for synchronizing a weight of keywords appearing in documents and a weight considering category information to generate a weight of keywords. Furthermore, Japanese Unexamined Patent Publication No. 1999-143796 discloses a technique for extracting main topics exchanged in each mailing list in the mailing list service.

In this way, it is very useful to arrange information and automatically extract topics and display them comprehensibly, so that there have been several proposals SO far. However, at the above portal sites, since the extraction of topics about news in the important fields is carried out manually, it is feared that the valuation basis for information might be biased only with a single site, some important information might be missed out, or all information about a certain topic might not be obtained. Intending to see a plurality of sites to avoid this fear, duplication of information might occur. In addition, since mixed standpoints are involved, it is necessary to rearrange the information from another standpoint in order for users to understand easily. Furthermore, regarding the news in the fields where so many readers are not expected, there is provided no service where information is arranged manually, thus users have to collect a plurality of sites by themselves and organize them.

On the other hand, the above document 1 does not include a technique for extracting some topic, and further despite using keywords in the retrieval equation for weighting of reference relations, it does not include a word itself in the result. The above document 2 does not consider whether a word has appeared newly or not. It uses the index that the number of information sources is large as the determination of the significance of clusters, rather than using the determination of words, thus the introduction of supports can not have an effect on the results of clustering.

Furthermore, in the above Japanese unexamined Patent Publication No. 1996-287074, static information sources (documents) are targeted to the bitter end, thus information from the same information sources such as the Internet is recognized as different documents. On this account, only the number of documents is considered in the calculation of the significance. Also it does not include structuralization between documents, so that it can not utilize the characteristics of document clustering, such as identifying words appearing frequently in some set of documents. Moreover, it deals with only words or compound words that have not been registered with the dictionaries as the target to be extracted, so that a sentence composed of a combination of registered words can not be extracted as a new concept. As a result, a sentence such as “Japan IBM releases new database product” is all composed of registered words, so that it can not be extracted as a new concept with this scheme. Furthermore, even if there are related new words, their similarity is not considered, so that related new words can not be seen at the same time, consequently the registration work for the related new words is to be done separately, where a similar set of documents is presented in each time, whereby working efficiency would not be increased. Also, the above Japanese unexamined Patent Publication No. 1999-143892 does not consider the temporal aspects and the dynamic characteristics of information sources. In addition, in the above Japanese Unexamined Patent Publication No. 1999-143796, the object is limited to a mailing list, further nothing but a single mailing list, therefor the information retrieval such as extracting topics from a plurality of information sources is difficult.

In order to solve the aforementioned problems, it is an object of the present invention to combine a plurality of information sources freely and display topical information from there in a comprehensible format.

It is another object of the invention to get the result of clustering in compliance with users' interests.

### SUMMARY OF THE INVENTION

In view of those purposes, the present invention periodically observes a plurality of dynamically changing information sources (which are referred to with URL, etc.) obtained from the Internet and others, and automatically extracts more important topics among the extracted information elements in view of support relations between sites and a degree of interest of individuals, and organize and visualize them in a comprehensible format. That is, in a first aspect of the present invention, a method for arranging information from information sources which are connected via network comprises the steps of: periodically circulating a plurality of registered information sources to collect information; selecting words for topical elements from the collected information; clustering the selected set of words; and based on the result of the clustering, displaying information elements in each cluster based on the time base, and at the same time displaying main keywords from among a set of words in each cluster as representative keywords of that cluster.

The displaying step includes the step of displaying supplementary information based on keywords included in a text part of the information elements in each cluster. Furthermore, when a plurality of words can be degenerated to one thing, the method further includes the step of making the degenerated thing a degenerated expression; and the displaying step includes the step of displaying the degenerated expression which has newly appeared in each cluster as supplementary information. According to the present invention, it is possible to visualize and display the obtained information in a comprehensible format to a user.

The selecting step includes the step of selecting the words which have newly appeared with highly weighting, thereby providing the newly appeared news to users preferentially. Furthermore, the selecting step includes the step of, for a specific information source where a specific word is selected, selecting words for topical elements in view of supports by the word from other information sources among the plurality of information sources, thereby selecting and providing topical information to users.

In another aspect of the present invention, a method for arranging information comprises the steps of: accepting a registration of information sources to acquire information therefrom and words a user has interest in from the user; periodically circulating the registered information sources to acquire information elements; selecting words the user has interest in among the acquired information elements with increasing a significance of the words; clustering a set of information elements including the selected words; and displaying the information elements clustered along with the result of the clustering. In addition, the method further includes the steps of: determining a degree of interest of the user in the individual information sources; and selecting words which have appeared in the information sources with a high degree of interest, with increasing a significance of the words. As the way to determine a degree of interest of a user, the user specifies a specific site, or a site where a corresponding information element has been selected by the user in the past is regarded as a site of a high degree of interest, for example.

In a further aspect of the present invention, a method for arranging information comprises the steps of: registering a plurality of sites to acquire information therefrom; periodically circulating the plurality of registered sites; investigating a change of contents due to, for example, a new word which has appeared during a specified period to collect information from the plurality of circulated sites; and extracting an important topic in view of supports by the word from other sites. The method further includes the steps of: clustering the extracted information elements having the important topic; and displaying the information elements obtained along with the result of the clustering. As a display of the result of the clustering, for example, the information elements in each cluster are displayed in time series, or a representative keyword or supplementary information in each cluster is displayed.

Furthermore, the method includes the steps of: calculating an amount of topics which individual sites have provided based on the number of extracted information elements; and accumulating an index showing a topic supply capacity of the sites based on the calculated amount of topics, whereby it is possible to weight sites or words based on the calculated topic supply capacity. In addition, as this application, it is possible to arrange sites in order of the index of topic supply capacity, and further to display its value.

In a further aspect of the present invention, an information processing apparatus comprises: specification means for specifying a plurality of sites to be circulated; storage means for storing the plurality of specified sites; information collection means for periodically circulating the plurality of stored sites to collect information; word selection means for selecting words for topical elements from the collected information; clustering means for clustering the selected set of words; and output means for, based on the result of the clustering, outputting information elements in each cluster and keywords in a set of words in each cluster.

The output means outputs the information elements in each cluster in time series, at the same time outputs supplementary information with keywords included in a text part of the information elements, thereby outputting how the extracted individual topics have changed in a comprehensible format.

Also the output means not only displays on a display device, but also outputs electronic information on a terminal connected via a network.

In a further aspect of the present invention, an information processing apparatus comprises: registration accept means for accepting a registration of information sources to acquire information therefrom and words a user has interest in from the user; circulation means for periodically circulating the accepted information sources to acquire information elements; selection means for selecting words the user has interest in among the acquired information elements with increasing a significance; clustering means for clustering a set of information elements including the selected words; and display means for displaying the information elements clustered along with the result of the clustering.

Further, the apparatus includes setting means for setting a high significance for information sources which the user has registered, or where a corresponding information element has been selected by the user in the past; and the selection means selects words which have appeared in the information sources where a high significance is set by the setting means, with increasing a significance of the words.

In a further aspect of the present invention, there is provided a storage media (e.g. CD-ROM) for storing a program readable by computer input means (e.g. CD-ROM driver) and executed by a computer, the program comprising: process for periodically circulating a plurality of registered information sources to collect information; process for selecting words for topical elements from the collected information; process for clustering the selected set of words; and process for, based on the result of the clustering, displaying information elements in each cluster based on the time base, at the same time displaying main keywords from among a set of words in each cluster as representative keywords of that cluster.

Here, the program includes a process of displaying supplementary information based on keywords included in a text part of the information elements in each cluster, using a degenerated expression that newly appeared in each cluster, thereby providing a more comprehensible display to a user.

In a further aspect of the present invention, there is provided a storage media for storing a program readable by computer input means and executed by a computer, the program comprising: process for registering a plurality of sites to acquire information therefrom; process for periodically circulating the plurality of registered sites; process for investigating a change of contents to collect information from the plurality of circulated sites; and extracting an important topic in view of supports by the word from other sites.

In a further aspect of the invention, there is provided a program transmission apparatus including a storage means for storing a program executed by a computer and a transmission means for transmitting the program stored in the storage means to a user terminal via the Internet, the program comprising: process for periodically circulating a plurality of registered information sources to collect information; process for selecting words for topical elements from the collected information; process for clustering the selected set of words; and process for, based on the result of the clustering, displaying information elements in each cluster based on the time base, at the same time displaying predetermined keywords from among a set of words in each cluster.

### BRIEF DESCRIPTION OF THE DRAWINGS

FIG. 1 is a diagram showing the outline of information extraction/display method according to the embodiment of the present invention.

FIG. 2 is a diagram illustrating the overall configuration of the system according the embodiment of the present invention.

FIG. 3 is a diagram showing the registered sites.

FIG. 4 depicts the configuration of the metadata create feature 20 in detail.

FIG. 5 depicts a link as an example of created metadata.

FIG. 6 depicts a text block as an example of created metadata.

FIG. 7 is a diagram illustrating a configuration of the new information extract and display feature 30.

FIG. 8 depicts a relation between the specified period and versions.

FIG. 9 depicts a sample structure of what is obtained as a result of clustering and its interpretation.

FIG. 10 depicts a concrete example of a result of clustering.

FIG. 11 depicts a sample display obtained by the above series of processing.

### DETAILED DESCRIPTION OF PREFERRED EMBODIMENT

Now the present invention will be described referring to the embodiments shown in the attached drawings.

First, the outline of the present invention will be described to facilitate the understanding of the present scheme before describing the system configuration of the embodiment.

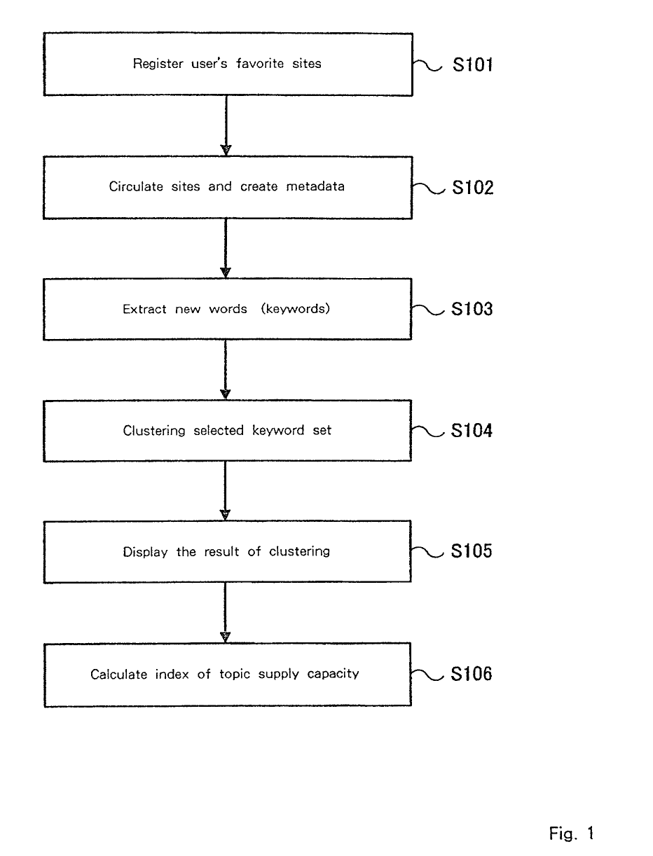

FIG. 1 is a diagram showing the outline of information extraction/display method according to the embodiment of the present invention. According to the present method, an individual selects information sources, arranges information by freely attaching a significance depending on a degree of interest, and implements a personal information site (Personal Portal) or dedicated site for specific fields (Vertical Portal) automatically.

For that purpose, first a user registers his or her favorite sites (step 101). Upon registration, the user specifies its name and reference (URL: Uniform Resource Locator), for example. Then, the system circulates the registered sites periodically at a specified time and compares its content with what is registered with the database. If the content differs, it is registered as a new version and metadata is created (step 102). This metadata is extracted from the contents referred to at the URL as elements for selecting information.

Next at individual sites in a site set registered, the method counts keywords which appeared in a version just before the specified period and in a version of the specified period, weights the set of keywords, and extracts new keywords (step 103). Thereafter, the method applies clustering to the selected keywords, using inclusion relations of information element sets including individual keywords and appended weights (step 104). The clustering is the work for clustering the keywords into sets in terms of meanings. Then, based on the result of the clustering, the method displays main representative keywords (hot words) of a keyword set in each cluster and displays an information element set in order of time, at the same time displays the result of the clustering by using keywords (subwords) as supplementary information (step 105). With this series of processing, a more important topic is to be extracted automatically in view of support relations among sites and a degree of interest of individuals, etc., in addition, they are organized and visualized in a comprehensible format. Thereafter, the method calculates, for the clusters extracted in this way, an index which indicates a capacity for individual sites to supply topics, based on the significance of the keywords (step 106). Hereby, using the significance calculated upon extraction of topics, there are presented the sites which have a high supply capacity of topics or the sites which have a high supply capacity of topics for specific words.

Next, the present method will be described in detail referring to the system configuration.

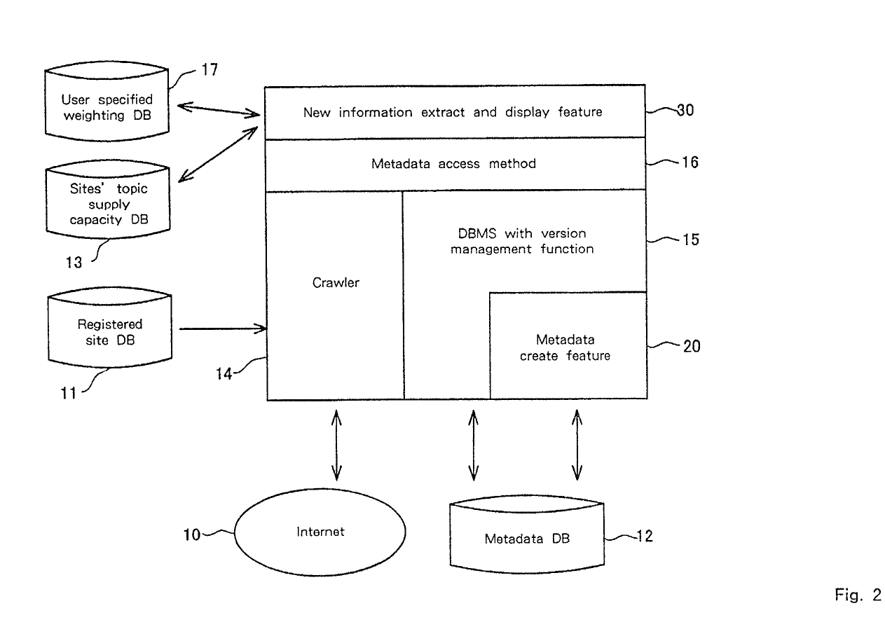

FIG. 2 is a diagram illustrating the overall configuration of the system according the embodiment of the present invention. The present system is implemented as a processing program of an application software on a personal computer (PC) connected to the Internet 10. Also the present system is able to be configured as a server which provides information to user PC terminals connected to the Internet 10. Outputs from this processing program are displayed to a display device in case of user PC terminals, or in case of server, outputs are provided to user PC terminals via Internet 10. Note that the embodiment will be mainly described about the processing flow in case of user PC terminals.

Furthermore, the processing program executed in this system is commonly stored in a hard disk drive (not shown) and loaded into a main memory (not shown) at run time to be executed by a CPU (not shown). Also, the processing program may be supplied to user PC terminals via storage media such as CD-ROM (not shown), or downloaded by users via Internet 10.

In FIG. 2, a symbol 11 is a registered site DB (database) which stores sites users registered, symbol 12 is a metadata DB which stores the aforementioned metadata, symbol 13 is a sites' topic supply capacity DB which stores the significance of sites obtained by calculating from the significance of keywords, and symbol 17 is a user specified weighting DB which stores the significance of user specified favorite keywords or sites, these of which are stored in a part of storage means such as a hard disk drive equipped with a PC, for example. Symbol 14 is a crawler which automatically circulate the registered sites over the Internet 10. Symbol 15 is a DBMS (Database Management System) with version management function for retaining and managing metadata of registered sites, which includes a metadata create feature 20 that extracts information elements from among HTML (Hypertext Markup Language), analyzes its text part, and retains keywords included there and their clusterings. Symbol 16 is a metadata access method which provides access means to data stored in the metadata DB 12. Symbol 30 is a new information extract and display feature which extracts and displays new topics based on information stored in the metadata DB 12.

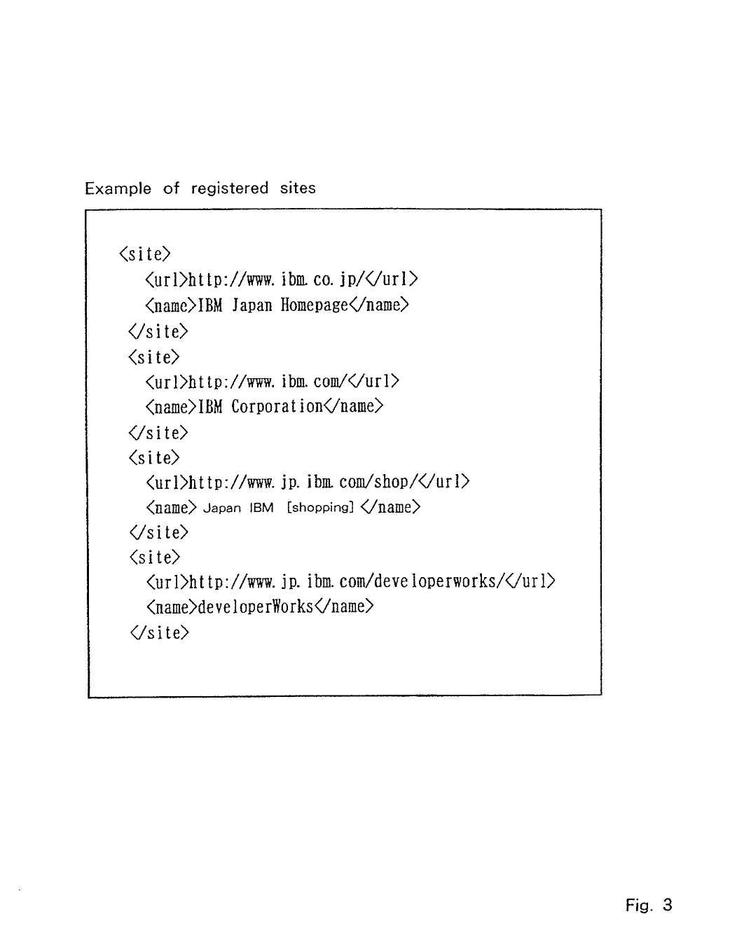

As mentioned above, in the registered site DB 11, users' favorite sites are registered. Upon registration, a user specifies its name and reference (URL). In an example shown in FIG. 3, four sites are registered and their registration format is XML (extensible Markup Language). Here, one way for a user to easily register a site is to cut and paste a directory list of a specific portal site.

The crawler 14 periodically circulates the registered sites in the registered site DB 11 at a specified time. For example, it circulates at 7:30 AM every morning. The crawler 14 may circulate all registered sites at the same time instant, or it is possible to specify different times to individual sites. When a different content is found upon the circulation by the crawler 14, the DBMS with version management function 15 manages it as a new version, and further creates metadata for it with the metadata create feature 20 and retains its result to the metadata DB 12. In this way, when a new version is created for sites, its metadata is created. This metadata is extracted from the contents referred to at the URL as elements for selecting information. The metadata includes a link and its text part or a series of text parts. In relation to the text parts of these information elements, the attribute extraction is applied and keywords and their clusterings are extracted.

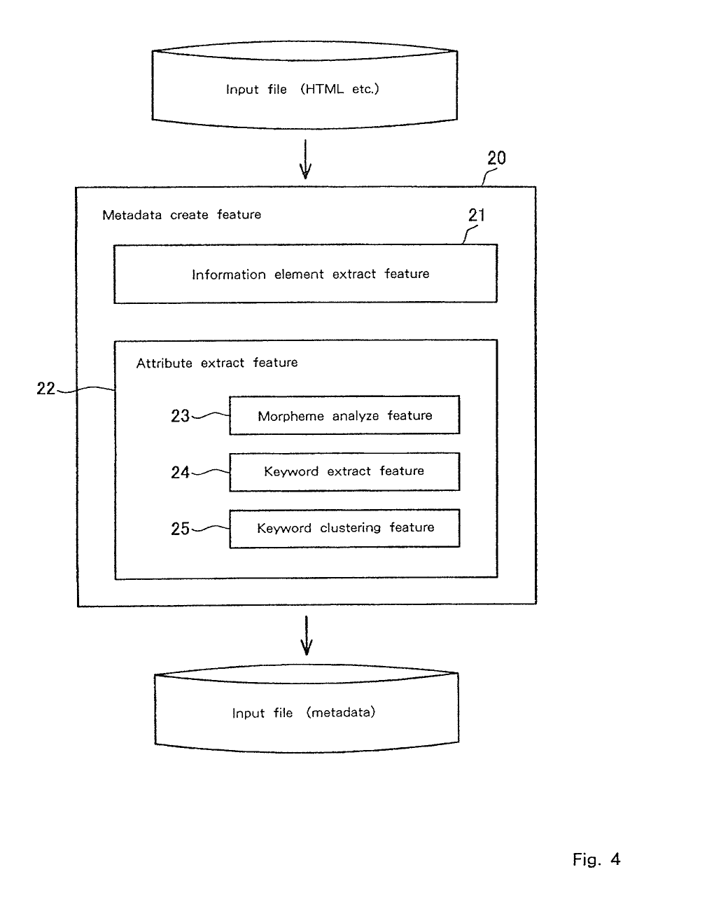

FIG. 4 depicts the configuration of the metadata create feature 20 in detail. As is shown in FIG. 4, this metadata create feature 20 creates metadata from input files such as HTML, and outputs it as an output file. Symbol 21 is an information element extract feature, which analyzes the contents of HTML, etc., and extracts information elements (links, texts, etc.). Symbol 22 is an attribute extract feature, which extracts keywords from texts of information elements extracted by the information element extract feature 21 and appends a category to it. The attribute extract feature 22 includes a morpheme analyze feature 23, a keyword extract feature 24, and a keyword clustering feature 25. The morpheme analyze feature 23 divides a text part of information elements extracted by the information element extract feature 21 into words. The keyword extract feature 24 extracts keywords from the resulting words divided by the morpheme analyze feature 23. The keyword clustering feature 25 appends a clustering of keyword extracted by the keyword extract feature 24.

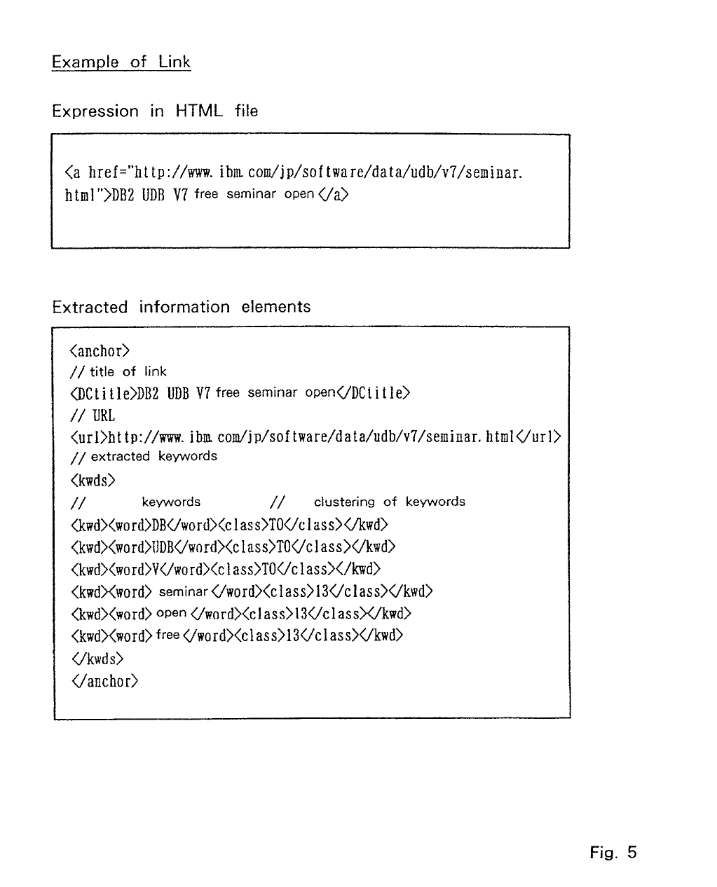

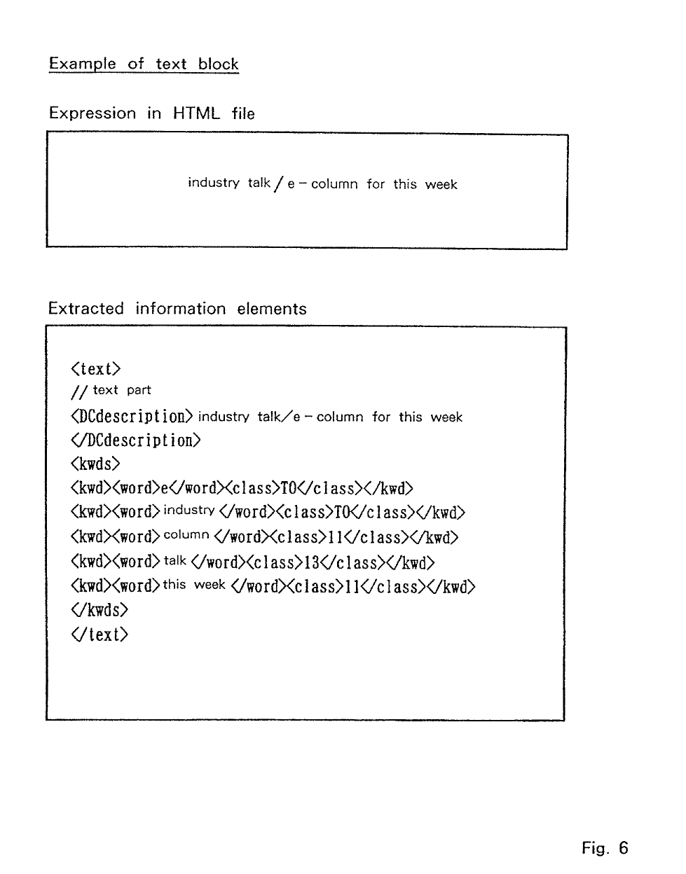

FIG. 5 depicts a link as an example of created metadata. Also, FIG. 6 depicts a text block as an example of created metadata. In FIG. 5, an expression in an HTML file in case of link is shown by “a” tag indicating the destination of link, and extracted information elements are composed of “anchor” tag. Also in FIG. 6, an expression in an HTML file in case of text block is a text expression, and extracted information elements are composed of “text” tag.

According to the above processing, when a change is found by the crawler 14 upon circulation at the registered sites on the registered site DB 11, its all contents and the metadata created by the metadata create feature 20 are registered with the metadata DB 12. Also, the date and time when the contents are changed (e.g., the data and time when the updated date and time is obtained from the web server, otherwise the date and time of circulation) are retained in the metadata DB 12.

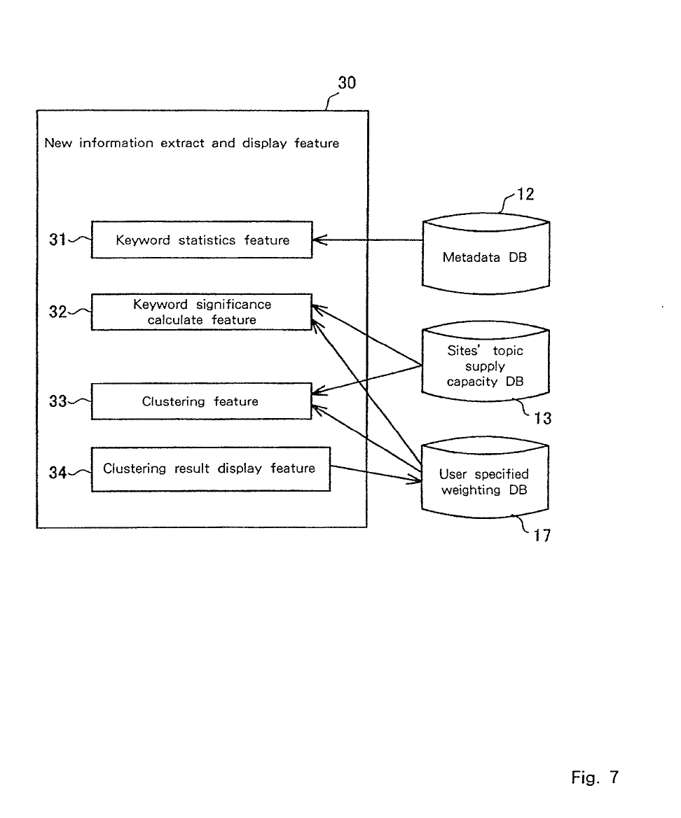

Next, in the new information extract and display feature 30, the extraction and clustering of new words is performed. FIG. 7 is a diagram illustrating a configuration of the new information extract and display feature 30. In FIG. 7, symbol 31 is a keyword statistics feature, which counts, from metadata for specified sites which are obtained from the metadata DB 12, keywords which newly appeared in a version of the specified period, and keywords which were included in the information elements in a version just before the specified period. The determination whether information elements newly appeared or not is as follows; i.e., in case of link, when a link of different URL appeared, or when the same URL exists but the corresponding text is different, it is regarded as a new link. Whereas in case of text block, it depends on whether a different text has appeared or not. Symbol 32 is a keyword significance calculate feature, which appends a significance to the extracted keywords. In the keyword significance calculate feature 32, the significance of the sites is set, referring to the sites' topic supply capacity DB 13. Symbol 33 is a clustering feature, which performs clustering using the extracted keywords with the significance appended. The significance of extracted clusters is calculated based on the significance, and the result is stored in the sites' topic supply capacity DB 13, as will be described later. Symbol 34 is a clustering result display feature, which displays the result of the clustering.

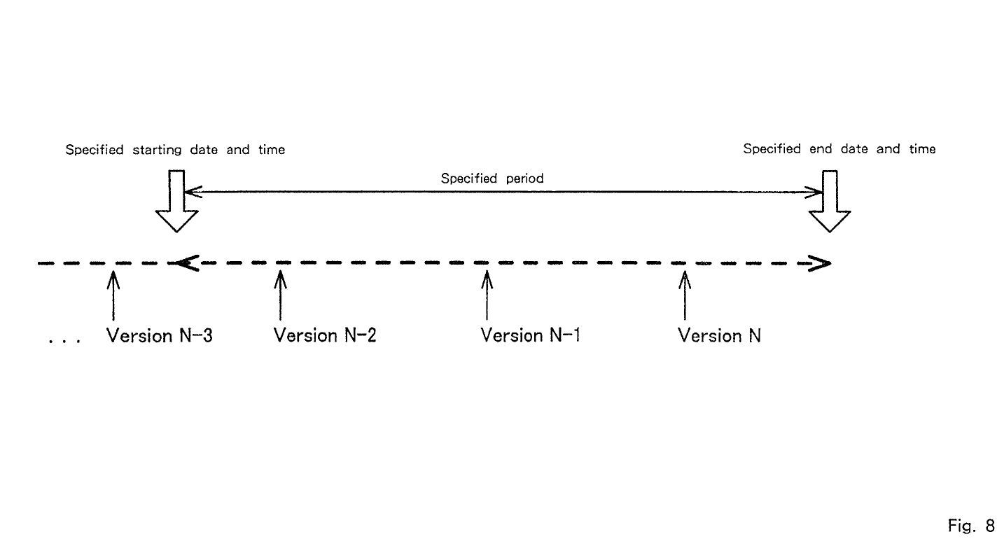

FIG. 8 depicts a relation between the specified period and versions. In the keyword statistics feature 31 shown in FIG. 7, keywords which appeared in a version just before the specified period shown in FIG. 8 and in a version of the specified period are counted, for individual sites in a site set registered with the registered site DB 11. Here, the count (Fs(w)) corresponding to the version (Version N-3) just before the specified starting date and time and the count (Fn(w)) corresponding to the following versions (Version N-2 to Version N) are distinguished. In the keyword significance calculate feature 32, these keyword sets are weighted and then judged whether they are a new keyword. As a selecting method, it is conceivable to combine weights for the significance of words and the significance of sites, and to remove the ones that are smaller than the threshold.

As the significance of words, the following example is considered.

(a) Consider the rate of simple new words, (Fn(w)/(Fs(w)+Fn(w))).

(b) Calculate an information volume of keywords in the past versions (all versions prior to Version N-3), and lower the significance of keywords with a low information volume. Hereby, the words that are necessarily appended to individual information, such as “release” in “release information of new products”, are lowered its significance.

(c) Consider whether the words are included in a plurality of sites (i.e., supported by a plurality of sites).

(d) Weight according to user specification. That is, register a word where a user has great interest (or has no interest) along with the significance, and heighten (or lower) the significance when it appears.

As a specification method, it is conceivable for a user to explicitly describe the significance for individual sites, or where the corresponding information elements are selected when the result of the clustering is finally displayed, heightening the weight of the site that includes those information elements.

As the significance of sites, one method is to make a degree of significance for individual sites set by a user the criterion. For example, a user registers a site where he or she has particular interest (or has no interest), and heightens (or lowers) the significance of words which appeared in that site.

As a specification method, it is conceivable for a user to explicitly describe the significance for individual sites, or where the corresponding information elements are selected when the result of the clustering is finally displayed, heightening the weight of the site that includes those information elements.

Next, the clustering of a selected keyword set will be described.

In the clustering feature 33 shown in FIG. 7, clustering is applied to a keyword set selected in the keyword statistics feature 31 using the weights appended in the keyword significance calculate feature 32. Any method may be used as this clustering, however, as a preprocessing for clustering, when a plurality of keywords include exactly the same keyword set and those keywords can be degenerated to one thing, the degenerated thing is made one keyword.

Here the degeneration includes the following, for example.

Orthography:

Transforming to orthography using an orthographic dictionary. For example, notation variants in English words such as “center” or “centre” are transformed into “center”.

Synonym:

Transforming to a regular expression using a synonym dictionary. For example, some Japanese words referring to the United States of America such as “beikoku”, “amerika-gassyukoku” are transformed to “beikoku”.

Compound word:

Transforming words appearing adjacently in all texts into one compound word. For example, “prime minister”, “obuchi” are transformed into “prime minister obuchi”.

Dependency structure:

Transforming words which have the same dependency relation in all texts into one expression. When a case marker is obtained, it is also appended. As a case marker corresponds a postpositional word in Japanese or a preposition in English. In the following example, a postpositional word “ga” is appended as case marker, i.e., “naikaku” (the Cabinet), “soujisyokul” (resign en mass) are transformed into “naikaku ga soujisyoku” (The Cabinet resigns en mass).

Next, an example of clustering will be described. First, the selected keywords are sorted in order of significance. Then, the information elements which include the keyword are assigned to individual keywords. Thereafter, inclusion relations (i.e., strong inclusion relations and weak inclusion relations) are determined. Upon determination of these inclusion relations, it is assumed that individual keywords are necessarily included in the keywords which have a high significance. Upon determination of the inclusion relations, for each of all keywords, keywords which have a higher significance than that keyword are all examined about the presence of inclusion relations. As to the presence of inclusion relations, when regarding the information elements associated with a keyword as a set, a strong inclusion relation exists when the rate of common elements is higher than the threshold. On the other hand, when some common information elements exist, but the rate of them does not reach the threshold, a weak inclusion relation is found. The keywords for which a strong inclusion relation is found are organized into one cluster, while the keywords for which a weak inclusion relation is found are organized into another cluster. Here, as an information element set included in the weak inclusion relation, such elements are excluded that are included in an information element set in a cluster associated with keywords which have a higher significance. And that keywords are included in the keyword set of higher significance cluster.

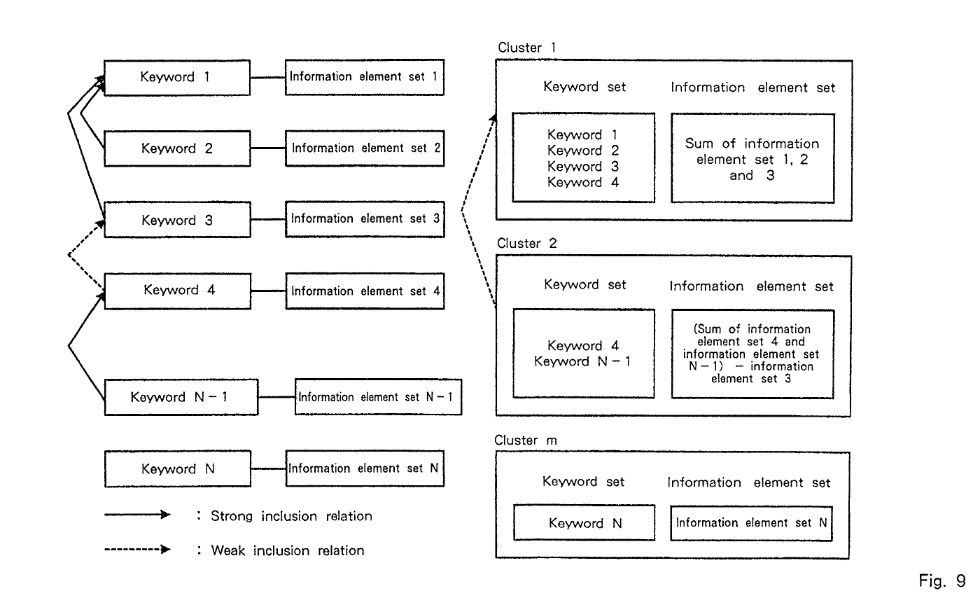

FIG. 9 depicts a sample structure of what is obtained as a result of such clustering and its interpretation. In the shown example, keyword 1 has strong inclusion relations with keyword 2 and keyword 3. There is also a strong inclusion relation between keyword 4 and keyword N−1. Keyword 4 also has a weak inclusion relation with keyword 3. As a result of the clustering, a set of cluster 1, cluster 2 and cluster m is formed. As a keyword set in the cluster 1, keywords 1 to 3 which have strong inclusion relations are organized, along with the keyword 4 which has a weak inclusion relation as a supplement. On the other hand, as an information element set, information element sets 1 to 3 corresponding to keywords 1 to 3 which have a strong inclusion relation are organized, but the information element set 4 is excluded. Since the information element set 4 outputs a text in a full state, the information element set having a weak inclusion relation is excluded in order to reduce information volume.

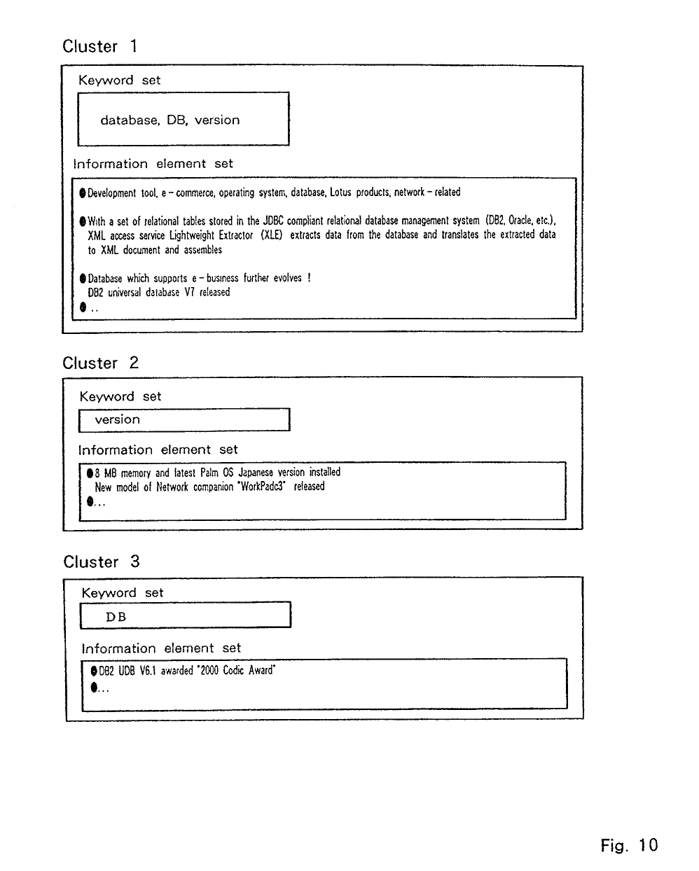

FIG. 10 depicts a concrete example of a result of clustering. Here, three clusters, i.e. cluster 1 to 3 are shown, where a keyword set and an information element set are formed, respectively. The cluster 2 and cluster 3 have a weak inclusion relation with cluster 1.

Next, a display of the result of clustering will be described.

The clustering result display feature 34 shown in FIG. 7 displays, from the result of the above clustering, a main keyword in a keyword set in each cluster (a keyword with the highest significance) as a representative keyword (hot word) of that cluster. Furthermore, it displays information elements in order of time among an information element set included in that cluster. At that time, it displays supplementary information as a subword using keywords included in a text part of information elements. This supplementary information is displayed when a single degenerated expression of keywords, or a plurality of keywords or degenerated expressions included in a keyword set of that cluster first appears. The display order of keywords and degenerated expressions is the same as the order of appearance in a text.

Referring to a concrete example shown in FIG. 10, regarding the display of the cluster 1, the oldest information element is first displayed. In its information elements “development tool, e-commerce, operating system, database, Lotus products, network-related”, there is only included “database” that is a keyword among a keyword set, so that no subword is displayed.

In the next information elements “With a set of relational tables stored in the JDBC compliant relational database management system (DB2, Oracle, etc.), XML access service Lightweight Extractor (XLE) extracts data from the database and translates the extracted data to XML document and assembles.”, there are included “database” and “DB” in the keyword set. Since a plurality of keywords are included here, a subword is created using them. Since the display order follows the order of appearance in the text in the information element set, so the display order is the following, i.e. “DB, database”. If these keywords appear consecutively in the text, they are displayed with their degenerated expression “DB database” (no comma displayed). This subword is stored, and when there is only “database” or “DB” included in the cluster 1, this subword will never displayed a gain.

Next, if there is any cluster having a weak inclusion relation with that cluster, it is displayed. Upon display of hot words, “indentation” is applied in order to indicate the presence of inclusion relation. Display of subwords is performed in the same way.

In this way, all clusters are displayed. Clusters with weak inclusion relations and hot words in clusters with weak inclusion relations are displayed with the same number of “indentations” as their levels.

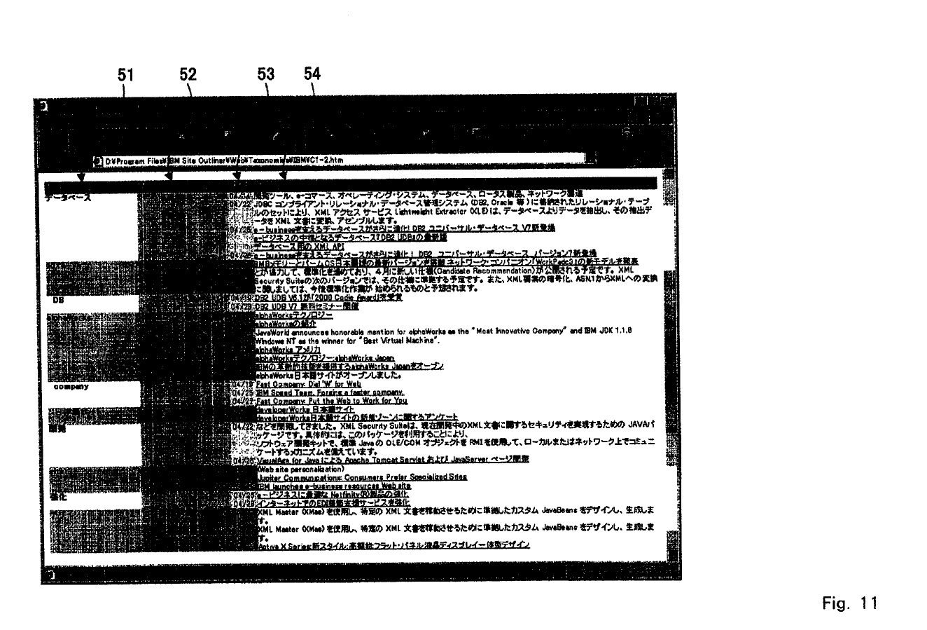

FIG. 11 depicts a sample display obtained by the above series of processing. In the display shown in FIG. 11, hot words 51 are displayed at the far left, subwords 52 are displayed next to them. As is seen from the date 53, information elements are displayed from the oldest one. In the reference article 54, there are displayed text blocks and link sentences shown with underlines as information elements. Furthermore, “version” and “DB”, which have an inclusion relation with a keyword “database” in the first tier of the hot word, are displayed with one tier dropped down according to the indentation, as is seen from the drawing. In this way, according to the embodiment of the present invention, the results of clustering are displayed in time series, where not only main keywords (hot words) in each cluster, but newly appeared degenerated expressions are displayed as supplementary information (subwords), further the corresponding information elements are displayed in time series. Hereby, information which is newer to a user and which a user wants can be provided in an arranged condition.

Finally, in the embodiment of the present invention, the index of topic supply capacity is calculated. That is, for the cluster extracted like this, a significance is calculated based on the significance of its keywords. The resulting significance is accumulated in the sites' topic supply capacity DB 13 in an additive way and updated, which is used for calculation of the significance of sites. At that time, the latest conditions should be reflected as much as possible with decreasing the past values. More specifically, an amount of topics which individual sites have provided are calculated by combining the words included in the extracted clusters, the number of information elements, or their weights, then the result is accumulated as an index which shows the sites' topic supply capacity. Regarding the words included in the cluster, the index showing sites' topic supply capacity by the word in the individual sites is accumulated. Also, with arranging sites in order of their topic supply capacity appended to them, or displaying their values, a user is presented about how much amount of new information the sites have provided so far. Furthermore, using the index of topic supply capacity by the word appended to individual sites, the index of information supply capacity can be presented for a specific word in individual sites. In addition, with displaying the sites which match the user specified keywords, for a word set with the index of topic supply capacity appended in the individual sites, the sites with high topic supply capacity can be presented for the keywords a user requires.

In this way, according to the embodiment of the present invention, with freely combining a plurality of information sources and extracting topical information therefrom, the topical information can be obtained from not a single information source but a set of information sources. That is, with registering a plurality of sites, periodically circulating them, and investigating a change of their contents, more important information can be extracted.

Also since the weight of words changes due to supporting a plurality of information sources, whereby the result of clustering changes, so that a more general cluster can be obtained in a set of sites. That is, with considering a support by the word from other sites, a more important topic is to be extracted. Likewise, with changing a degree of interest of users in words and sites, the result of clustering can be obtained according to users' interest.

Moreover, with displaying the obtained texts with the result of clustering by using supplementary information, how the individual topics extracted have changed is displayed in a comprehensible format.

As mentioned above, according to the present invention, with freely combining a plurality of information sources, topical information can be displayed therefrom in a comprehensible format.

Description of the Symbols is repeated herein for quick reference:

10: Internet

11: Registered site DB

12: Metadata DB

13: Sites' topic supply capacity DB

14: Crawler

15: DBMS with Version management function

16: Metadata access method

17: User specified weighting DB

20: Metadata create feature

21: Information element extract feature

22: Attribute extract feature

23: Morpheme analyze feature

24: Keyword extract feature

25: Keyword clustering feature

30: New information extract and display feature

31: Keyword statistics feature

32: Keyword significance calculate feature

33: Clustering feature

34: Clustering result display feature

51: Hot word

52: Subword

53: Date

54: Reference article

Having described embodiments of the invention it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claims and desired protected by Letters Patent required by the patent laws, what is claims and desired protected by Letters Patent is set for in the appended claims.

What is claimed is:

1. A method for arranging information from information sources which are connected via network, comprising the steps of:
periodically circulating a plurality of registered information sources to collect information;
selecting words for topical elements from the collected information;
clustering the selected set of words; and
based on the result of the clustering, displaying information elements in each cluster based on the time base, and at the same time displaying main keywords from among a set of words in each cluster as representative keywords of that cluster.

2. The method according to claim 1, wherein said displaying step comprises the step of displaying supplementary information based on keywords included in a text part of the information elements in each cluster.

3. The method according to claim 2, wherein when a plurality of words can be degenerated to one thing, further comprising the step of:
making the degenerated thing a degenerated expression; and
said displaying step includes the step of displaying the degenerated expression which has newly appeared in each cluster as supplementary information.

4. The method according to claim 1, wherein said selecting step comprises the step of selecting the words which have newly appeared with highly weighting.

5. The method according to claim 1, wherein said selecting step comprises the step of, for a specific information source where a specific word is selected, selecting words for topical elements in view of supports by the word from other information sources among said plurality of information sources.

6. A method for arranging information, comprising the steps of:
accepting a registration of information sources to acquire information therefrom and words a user has interest in from the user;
periodically circulating the registered information sources to acquire information elements;
selecting words the user has interest in among the acquired information elements with increasing a significance of said words;
clustering a set of information elements including the selected words; and
displaying the information elements clustered along with the result of the clustering.

7. The method according to claim 6, further comprising the steps of:
determining a degree of interest of the user in the individual information sources; and
selecting words which have appeared in the information sources with a high degree of interest, with increasing a significance of said words.

8. A method for arranging information, comprising the steps of:
registering a plurality of sites to acquire information therefrom;
periodically circulating the plurality of registered sites;
investigating a change of contents to collect information from the plurality of circulated sites; and
extracting an important topic in view of supports by the word from other sites.

9. The method according to claim 8, further comprising the steps of:
clustering the extracted information elements having the important topic; and
displaying the information elements obtained along with the result of the clustering.

10. The method according to claim 8, further comprising the steps of:
calculating an amount of topics which individual sites have provided based on the number of extracted information elements; and
accumulating an index showing a topic supply capacity of the sites based on the calculated amount of topics.

11. An information processing apparatus, comprising:
specification means for specifying a plurality of sites to be circulated;
storage means for storing the plurality of specified sites;
information collection means for periodically circulating the plurality of stored sites to collect information;
word selection means for selecting words for topical elements from the collected information;
clustering means for clustering the selected set of words; and
output means for, based on the result of the clustering, outputting information elements in each cluster and keywords in a set of words in each cluster.

12. The information processing apparatus according to claim 11; wherein the output means outputs the information elements in each cluster in time series, at the same time outputs supplementary information with keywords included in a text part of the information elements.

13. The information processing apparatus according to claim 11, wherein the output means not only displays on a display device, but also outputs electronic information on a terminal connected via a network.

14. An information processing apparatus, comprising:
registration accept means for accepting a registration of information sources to acquire information therefrom and words a user has interest in from the user;
circulation means for periodically circulating the accepted information sources to acquire information elements;
selection means for selecting words the user has interest in among the acquired information elements with increasing a significance;
clustering means for clustering a set of information elements including the selected words; and
display means for displaying the information elements clustered along with the result of the clustering.

15. The information processing apparatus according to claim 14, further comprising:
setting means for setting a high significance for information sources which the user has registered, or where a corresponding information element has been selected by the user in the past; and
said selection means selects words which have appeared in the information sources where a high significance is set by said setting means, with increasing a significance of said words.

16. A storage media for storing a program readable by computer input means and executed by a computer, the program comprising:
process for periodically circulating a plurality of registered information sources to collect information;
process for selecting words for topical elements from the collected information;
process for clustering the selected set of words; and
process for, based on the result of the clustering, displaying information elements in each cluster based on the time base, at the same time displaying predetermined keywords from among a set of words in each cluster.

17. The storage media according to claim 16, the program further comprising a process of displaying supplementary information based on keywords included in a text part of the information elements in each cluster, using a degenerated expression that newly appeared in each cluster.

18. A storage media for storing a program readable by computer input means and executed by a computer, the program comprising:
process for registering a plurality of sites to acquire information therefrom;
process for periodically circulating the plurality of registered sites;
process for investigating a change of contents to collect information from the plurality of circulated sites; and
extracting an important topic in view of supports by the word from other sites.

19. A program transmission apparatus including a storage means for storing a program executed by a computer and a transmission means for transmitting the program stored in said storage means to a user terminal via the Internet, the program comprising:
process for periodically circulating a plurality of registered information sources to collect information;
process for selecting words for topical elements from the collected information;
process for clustering the selected set of words; and
process for, based on the result of the clustering, displaying information elements in each cluster based on the time base, at the same time displaying predetermined keywords from among a set of words in each cluster.
